(19) United States
(12) Patent Application Publication
(10) Pub. No.: US 2021/0191368 A1
(43) Pub. Date: Jun. 24, 2021

(54) VIRTUAL JOB CONTROL

(71) Applicant: Halliburton Energy Services, Inc., Houston, TX (US)

(72) Inventors: Derek Ray Williams, Duncan, OK (US); Charles Edward Neal, III, Duncan, OK (US)

(21) Appl. No.: 17/053,643

(22) PCT Filed: Nov. 28, 2018
(86) PCT No.: PCT/US2018/062729

§ 371 Date: Nov. 6, 2020

Related U.S. Application Data
(60) Provisional application No. 62/682,408, filed on Jun. 8, 2018.
(60) Provisional application No. 62/682,391, filed on Jun. 8, 2018.
(60) Provisional application No. 62/682,341, filed on Jun. 8, 2018.
(60) Provisional application No. 62/682,358, filed on Jun. 8, 2018.
(60) Provisional application No. 62/682,374, filed on Jun. 8, 2018.

(51) Int. Cl. G05B 19/4155; G06F 3/14; E21B 41/00; E21B 33/13; G06Q 10/10

(52) U.S. Cl. CPC G05B 19/4155; G06F 3/14; G05B 2219/34338; E21B 33/13; G06Q 10/103; E21B 41/00

(57) ABSTRACT

To reduce costs and improve efficiency: of one or more operations associated with a hydrocarbon recovery, exploration, operation or services site, a control system utilizes one or more sensors to obtain real-time data associated with one or more pieces of equipment at one or more sites, utilizes one or more audio-visual devices to provide one or more notifications based, at least in part, on the real-time data, utilizes one or more control devices to produce one or more commands based, at least in part, on the one or more notifications, and utilizes a network, system to provide the one or more commands to one or more pieces; of equipment at the one or more sites to control the one or more pieces of equipment Farther, a method is presented for collecting real-time data, providing notifications from an audiovisual device based, at least in part, on the on-site data associated with one or snore pieces of equipment at one or more sites, generating a command from, a control device, providing the command to one or more pieces of equipment; and controlling the one or more on-site equipment based, at least in part, on the command.

### TECHNICAL FIELD

The present disclosure relates generally to access to resources and equipment and related data at a hydrocarbon recovery, exploration, operation, or services environment and, more particularly, to access and control of resources and equipment involved in a hydrocarbon recovery exploration, operation, or services environment from a remote location based, at least in part, on data associated with the resources and equipment.

### BACKGROUND

Knowledge experts in various technological fields are often needed temporarily at a hydrocarbon recovery, exploration. Operation, or services environment. Such experts give advice, collaborate, and provide assistance in job design, job execution, job safety and general problem solving. However, many drilling sites are in remote regions, whether on land or offshore, where it is difficult and expensive for a knowledge expert to be present, especially if the knowledge expert is needed for only a short time period or for a small project. Despite the expense, it is generally necessary for the knowledge expert to be physically present on site because the knowledge expert needs to see, hear, and interact with resources, equipment, and personnel in the given hydrocarbon recovery, exploration, operation or services environment. To date, hands-on experience is frequently the most effective way for a knowledge expert to provide assistance in such an environment.

Even more, if a knowledge expert is needed at multiple sites, the expert need to travel to each of the multiple sites. In such cases, the cost of travel may be high, and delays associated with the expert's travel may delay critical on-going operations until the expert arrives on-site. A multi-location collaborative approach is needed to accommodate the limitations on a knowledge expert's time and to enable the efficient use of available resources.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a block diagram of an illustrative remote monitoring and control system, according to one or more aspects of the present disclosure.

FIG. 2 is a flow diagram of a method, according to one or more aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present. disclosure relates generally to access to resources and equipment and related data at a hydrocarbon recovery, exploration, operation, or services environment and, more particularly, to access and control of resources and equipment involved in a hydrocarbon recovery, exploration, operation, or services environment from a remote location based, at least in part, on data associated with the resources and equipment.

Illustrative embodiments of the present disclosure are described in detail herein. In the interest of clarity, not all features of an actual implementation are described in this specification. It will, of course, be appreciated that in the development of any such actual embodiment, numerous implementation-specific decisions must be made to achieve developers' specific goals, such as compliance with system-related and business-related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following example be read to limit or define the scope of the disclosure.

Disclosed herein is a virtual job control system comprising one or more sensors for collecting data associated with one or more well-site equipment; an audio-visual device for receiving the data and generating one or more notifications based, at least in part an the data; a control device for generating one or more commands based, at least in part, on theme or more notifications, wherein the one or more commands alter one or more operations of the well-site equipment; and a network system coupled to the one or more sensors, the one or more well-site equipment, the audio-visual device, and the control device.

In one or more embodiments, the audio-visual device may be an optical device that is one or more of wearable and portable. In one or more embodiments, the audio-visual device may generate the one or more notifications in at least one of one or more augmented reality environments and one or more of virtual reality environments. In one or more embodiments, the data collected by the one or more sensors may further comprise real-time data, and the audio-visual device may receive the real-time data and generate the one or more notifications in real-time based, at least in part, on the real-time data.

In one or more embodiments, the virtual job control system may further comprise a computer, wherein the computer may comprise a processor, and wherein the processor may execute one or more instructions that at least one of prompts the one or more sensors to collect data, receives the data from the one or more sensors, prepares the data for the audio-visual device, receives one or more commands from the control device, and transmits the one or more commands to the one or more well-site equipment. In one or more embodiments, the virtual job control system may further comprise a storage system for storing the data, wherein the storage system is coupled to the network system. In one or more embodiments, the one or more well-site equipment may be in a first location and at least one of the audio-visual device and the control device may be in a second location.

In one or more embodiments, the one or more well-site equipment may comprise cementing well-site equipment, and wherein the data collected by the one or sensors may comprise one or more of one or more cement properties, one or more slurry properties, and one or more performance indicators. In one or more embodiments, the one or more well-site equipment may comprise one or more of one or more actuators and one or more valves, wherein at least one of the one or more actuators and the one or more valves are associated with one or more cementing operations.

Disclosed herein is a method for controlling well-site equipment comprising collecting data associated with one or more well-site equipment; providing one or more notifications using an audio-visual device based, at least in part, on the data; generating a command using a control device based, at least in part, on the one or more notifications; and controlling the one or more well-site equipment based, at least in part, on the command.

In one or more embodiments, the one or more well site equipment may be in a first location and at least one of the audio-visual device and the control device may be in a second location. In one or more embodiments, collecting the data may further comprise using one or more sensors. In one or more embodiments, controlling the one or more well-site equipment may further comprise transmitting the command to the one or more well-site equipment via one or more of a local area network and a wide area network.

In one or more embodiments, the one or more notifications may comprise at least one of one or more audio notifications, one or more visual notifications, and one or more haptic notifications. In one or more embodiments, the one or more notifications may comprise at least one of one or more alarms, one or more warnings, one or more videos, one or more documents, one or more maintenance information, one or more diagnostics, and one or more help guides. In one or more embodiments, providing the one or more notifications may further comprise displaying the data in at least one of one or more augmented reality environments and one or more of virtual reality environments. In one or more embodiments, the data associated with one or more well site equipment may be real-time data.

Disclosed herein is a method for controlling well-site equipment comprising collecting data associated with one or more well-site equipment; providing one or more notifications using an audio-visual device based, at least in part, on the data and based, at least in part, on at least one of one or more configuration settings and one or more access controls; generating a command using a control device based, at least in part, on the one or more notifications; and controlling the one or more well-site equipment based, at least in part, on the-command.

In one or more embodiments, the method may further comprise storing the data in a data repository. In one or more embodiments, the method may further comprise transmitting the command to the one or more well-site equipment via one or more of a local area network and a wide area network.

To reduce expenses associated with an experts (for example, an expert intermediary) travel to work sites in hydrocarbon recovery, exploration, operation, or services environments, systems and methods for virtual presence and engagement with resources, equipment; and personnel are disclosed. An expert intermediary may be a person, a processing system such as an information handling system, a robot, a mechanical system, or any other person or device that operates to perform one or more necessary functions or operations required by the hydrocarbon recovery, exploration, operation, or services environment. Specifically, the disclosed embodiments are directed to systems and methods for enabling knowledge experts to be virtually present and engaged at a remote location at an interactive level that rivals being physically present. The disclosed embodiments are further directed to systems and methods for allowing remote data collection, monitoring, job design, and operation to be executed from one or more remote operation centers. Such methods may use various local- and remotely-enabled elements for data acquisition, data communications and sharing, data display and provision, job monitoring and control, teleconferencing, and system monitoring and control.

While one or more methods and systems may include certain existing technologies, including without limitation teleconferencing, live video and audio streaming, data sharing, and remote network access, a cohesive and integrated combination of these technologies for use in a hydrocarbon recovery, exploration, operation, or services environment does not exist. Further, existing technologies fall short of offering control of well-site equipment using a virtual or augmented reality device from a remote location. Disclosed herein are methods and systems providing a system that allows the operator to control equipment in a virtual or augmented reality manner by communicating directly with a control system to acquire real-time data as well as being able to issue control commands generated by physical gestures or accessory devices, such as a mouse or controller. Such methods and systems may be provided to operators to enable both on-site and remote access and control.

Specifically, the present disclosure discusses an integrated combination of technologies enabling expert-driven remote site assistance for delivering high quality well service in a hydrocarbon recovery, exploration, operation, or services environment that may be in one or more remote land locations and remote offshore locations. The technology of the virtual job control system disclosed herein may comprise audio-visual devices capable of displaying one or more virtual reality (VR) environments and one or more augmented reality (AR) environments using live network connections to provide access to on-site data, resources, and equipment. Audio-visual devices may also provide notifications as one or more of one or more audio and one or more haptic or vibrational cues. Such technology also may include sensors distributed through the work-site including without limitation sensors associated with one or more equipment, body cameras, area cameras, body microphones, and area microphones that may provide on-site data including without limitation live video and audio to resources and users on- and off-site. Such technology may further include networked automation and control equipment with the capacity to receive and transmit live job data on- and off-site. Such technology also may include remote operation centers and collaboration software to allow remote experts access to the previously mentioned technology in real-time to enable remote control of on-site equipment and resources during job execution.

Remote and virtual control of resources and equipment used in hydrocarbon recovery, exploration, operation, or services may provide a variety of benefits. The present disclosure enables an operator, who may be physically located off-site, to monitor and control resources and equipment at a site in a hydrocarbon recovery, exploration, operation or services environment. Accordingly, remotely-controlled equipment, and supporting systems, may enable rig optimizations and cost savings including without limitation reduction or elimination of equipment required for on-site monitoring and control. An augmented reality system as disclosed herein may, for example, enable removal of a physical control stand, freeing rig space for additional equipment for improved operations and eliminating costs associated with adding and maintaining the physical control stand.

Similarly, certain safety equipment typically required for on-site operator safety may be eliminated. For example, high pressure pumping typically requires an operator, at some personal risk, to be present on a skid to monitor and control the high pressure pumping job. The present disclosure enables removal of and cost savings associated with on-site safety equipment where an operator may remotely monitor and control equipment from off-site.

Remotely controlled equipment may further improve safety and efficiency because an experienced operator may control equipment without travel to a work-site. For example, operations at a work site may require fewer personnel on-site if knowledge experts can remotely monitor and control resources and equipment, thus limiting the number of personnel exposed to risks on-site. Additionally, an experienced operator or subject matter expert need not waste time and expense to travel to a work site when the experienced operator can just as easily interact with on-site equipment from a remote location.

Further, an operation involving hydrocarbon recovery, exploration, operation, or services may enjoy yet additional benefits by co-locating two or more users, for example, two or more subject matter experts, at an off-site location. A user may comprise a person or individual, a subject matter expert, an operator, personnel, a system, any other type of user, and any combination thereof. Co-located expert personnel may benefit from interaction with one another while simultaneously providing expertise to operators on-site, monitoring and allocating use of on-site resources, and controlling on-site equipment from a remote location. For example, a user remotely diagnosing an on-site issue while co-located with one or more peers may collaborate with said peers to more quickly identify a solution to the on-site issue. Additionally, a data collection, storage, and analysis system may be co-located with one or more subject matter experts to optimize receipt, storage, and analysis of data from one or more work sites and thereby improve troubleshooting, optimization, equipment and resource use, and maintenance of remote equipment. Such a system may further provide for improved industrial internet of things utilization and communication between various users including without limitation different types of users, for example, subject matter experts and other personnel or operators.

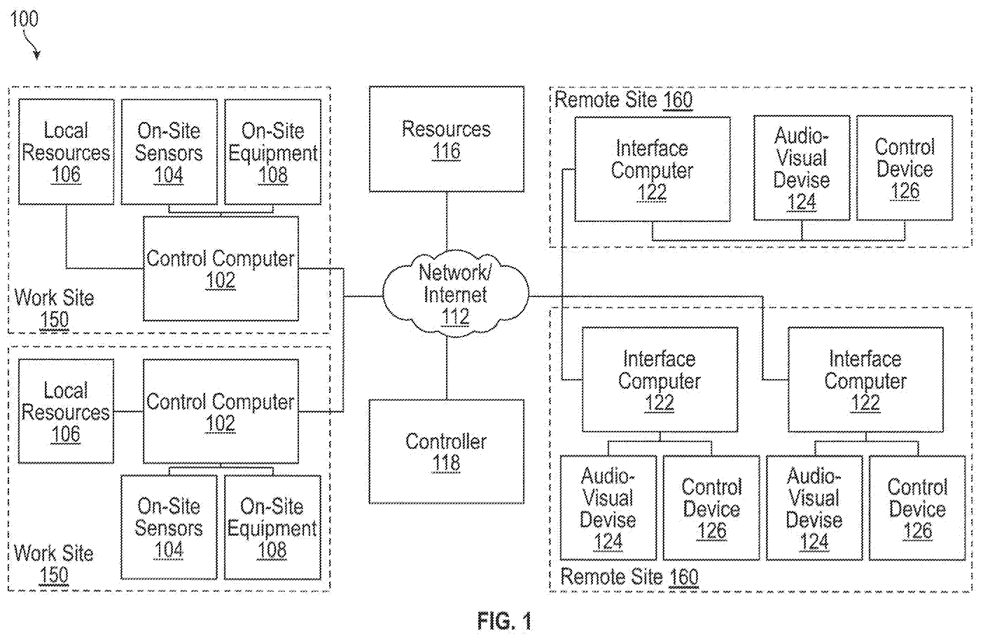

FIG. 1 is a block diagram of an illustrative remote monitoring and control system 100, according to one or more embodiments. System 100 may comprise one or more work sites 150 and one or more remote sites 160 where each of the one or more work sites 150 and each of the one or more remote sites 160 may be communicatively coupled together by a network. A work site 150 may comprise one or more control computers 102, one or more sensors 104, one or more local resources 106, and one or more pieces of on-site equipment 108. A remote site 160 may comprise one or more interface computers 122, one or more audio-visual devices 124, and one or more control devices 126. The system may further comprise one or more general resources 116. Although the system 100 may be deployed in any suitable context, this disclosure describes the system in the context of an oil and gas corporation. The system 100 is not limited to these examples.

One or more interface computers 122 at a remote site 160 may be coupled to one or more audio-visual devices 124 and one or more control devices 126. In one or more embodiments, an interface computer 122 may provide data from one or more work sites 150 to an audio-visual device 124 used by a user and may receive commands from a control device 126 used by the user to control equipment at one or more work sites 150. Audio-visual devices 124 may provide a variety of data and information including without limitation historical data, well logs, geographical data, and geophysical data. Specifically, audio-visual devices 124 may provide data related to one or more of volumes, levels, weights, temperatures, pressures, rates, densities, speeds, positions, torques, viscosities, conductivities, pH levels, valve positions, engine and motor information, and other data associated with any one or more systems, equipment, and devices at the hydrocarbon recovery, exploration, operation or services environment. Data may be provided in a variety of formats including without limitation communications, alarms, warnings, videos, documents, maintenance information, diagnostics, and help guides. In one or more embodiments, data provided may be real-time data.

In one or more embodiments, the audio-visual device 124 may comprise augmented or virtual reality devices that may be worn on a human head in a manner similar to eyeglasses. Augmented reality may be a live view of a physical, real-world environment whose elements are augmented by computer-generated sensory input, such as sound, video, graphics, or global positioning system (GPS) data. In contrast, virtual reality may be a completely fabricated environment comprising computer-generated sensory inputs including without limitation sound, video, graphic, and haptic or vibrational inputs. Images in an AR or VR environment may correspond to data from one or more pieces of equipment, one or more of video and audio from monitoring devices at a work site 150, and any other suitable source.

As noted above, data provided by audio-visual devices 124 may he presented in an AR environment or VR environment. Because AR devices provide a composite view of the real world with superimposed computer-generated graphics, AR applications may be suited to applications in which an operator may move and interact with his or her environment. In contrast, because VR applications limit a user's view to a computer-generated simulation, VR applications may be suited to an environment in which a user is in a stationary position.

A remote user may, based on the information provided by audio-visual devices 124 and possibly with the use of a control device, monitor and control work site resources and equipment, provide information to work site personnel, and communicate with other electronic devices via network 112. Data provided to a user may vary based, at least in part, on one or more configuration settings and one or more access controls. For example, a configuration setting may enable a user to display certain data and hide other information. In another example, access controls may enable certain users to access on-site data while preventing other users from accessing on-site data.

While audio-visual devices 124 are illustrated, the present disclosure contemplates any wearable or portable device that may be used to receive notifications, including eyewear, helmets, implantable devices, wristbands, and smartwatches. All such wearable devices may have some or all of the attributes ascribed to the eyewear devices herein, and may at a minimum have the attributes necessary to perform the actions described herein. All such wearable devices are contemplated and included within the scope. of the disclosure. Audio-visual devices 124 may further comprise communication features enabling communication between two or more audio-visual devices 124, or between one or more audio-visual devices 124 and other communication devices.

Audio-visual devices 124 may be accompanied by or otherwise associated with one or more control devices 126. Control device 126 may be integrated With the audio-visual devices 124 or may be separate device. Control device 126 may enable a user to interact with data provided on audio-visual devices 124 and enable command generation via one or more gestures, motions, button presses, selections, and voice commands.

A work site 150 may comprise one or more on-site equipment 108. On-site equipment may be responsive to commands generated by control device 126. In one or more embodiments, on-site equipment 108 may be coupled to control computer 102 and control computer 102 may be coupled to network 112. Control computer 102 may receive commands and interpret or modify commands to provide instructions to on-site equipment 108 to control on-site equipment. In one or more embodiments, on-site equipment 108 may be network-enabled and coupled directly to network 112 (not shown), such that on-site equipment 108 directly receives and interprets commands from control device 126. The responsiveness of on-site equipment to commands from control device 126 is not limited to these examples.

A work site 150 may further comprise local resources 106 that may be coupled to control computer 102. Resources may be local resources 106 when located at a work site 150, may be located off-site (shown as resources 116 in FIG. 1) and may be remote resources when located at a remote site 160 (not shown). Resources 106 may comprise a storage system such that the control computer 102 at a work site 150, or an interface computer 122 at a remote site 160, may store site information. As shown in FIG. 1, the remote monitoring and control system may further comprise multiple resources. Resources 116 and local resources 106 may comprise any and all data, information, equipment, and systems that facilitate operations at one or more remote sites 160 and one or more work sites 150. Resources 116 and local resources 106 may be stored on various types of storage (for example, servers not specifically shown) and may include without limitation wellbore data, drilling logs, well logs, geological data, geophysical data, historical data of all kinds, equipment data, databases, software applications, workflows, corporate policies and procedures, personnel data and directories, specific persons, and other information. Resources may be stored at a particular site or distributed across various locations for redundancy, availability, and any other purpose.

A work site 150 may further comprise one or more on-site sensors 104. In one or more embodiments, sensors 104 may be configured to continuously monitor and provide data to control computer 102 and local storage in local resources 106. In one or more embodiments, control computer 102 may periodically poll on-site sensors 104 for current data. On-site data may include without limitation volumes, levels, weights, temperatures, pressures, rates, densities, speeds, positions, torques, viscosities, conductivities, pH levels, valve positions, engine and motor information, and other data associated with any one or more systems, equipment, and devices at the hydrocarbon recovery, exploration, operation or services environment. Data may be provided to one or more devices including without limitation storage, such as local storage and remote storage, one or more control computers 102, and one or more interface computers 122 at a remote site 160. An interface computer 122 may provide this data to one or more audio-visual devices 124 for provision to a user or operator and to enable the user or operator to respond based, at least in part, on the data provided by the one or more sensors 104. In one or more embodiments, data from one or more sensors 104 may be real-time data. In one or more embodiments, a sensor 104 may be associated with a particular piece of equipment 108. For example, an on-site sensor 104 associated with a concrete operation may sense one or more slurry properties and provide the slurry property data to a control computer 102 for one or more of storage and distribution via network 112.

In one or more embodiments, on-site equipment 108 may comprise cementing equipment. Cementing equipment may comprise one or more cementers, one or more actuators, and one or more valves. One or more sensors 104 associated with the cementing equipment may collect data related to one or more cementing properties, one or more slurry properties, and one or more performance indicators. Performance indicators may comprise at least densities and rates for comparison of planned versus actual error bands for the densities and rates. Sensors 104 may further collect performance data regarding operation of one or more valves, including whether the one or more valves operates within a specific time range.

In one or more embodiments, on-site equipment 108 may comprise a device, such as a Programmable Logic Controller (PLC), for control of the equipment 108. A PLC may be coupled to one or more on-site resources or pieces of equipment 108 and may be configured to interpret commands (for example, from a control device) to manipulate said on-site resources 106 and equipment 108. For example, commands may adjust resource and equipment 108 settings including without limitation valve positions, pump speeds, and engine and motor speeds, in one or more embodiments, a PLC or similar equipment may be configured to handle complex control algorithms. For example, a PLC may be configured to handle algorithms for mixing and pumping services such as those found in cementing operations in the oil and gas industry.

Remote sites 160 and work sites 150 may be communicatively coupled to a network 112. Network 112 may be any suitable computer network that enables multiple computing devices to communicate with each other. Network 112 may comprise, without limitation, the Internet, a virtual private network, a local area network, a wide area network, and any other such network or combination of networks. Network 112 may be a public network or a private/restricted network and may comprise a primary and secondary network that need not be the same type of network. Further, each remote site 160 and each work site 150 may comprise one or more networks which may be coupled together to form a larger network. For example, a remote site 160 may comprise a secondary network, such as a wireless network, that may be communicatively coupled to a company intranet that is in turn coupled to the Internet which is in turn coupled to a wireless network at a remote site 160. In one or more embodiments, a work site 150 may be accessible for network communication at a single address (for example, an IP address). In one or more embodiments, a single IP address may enable simplified data collection or command addressing.

Network 112. may comprise any network topology, including without limitation wired and wireless solutions, direct and indirect coupling between nodes, local area networks (LANs), wide area networks (WANs), and low power WANs (LPWANs). Wireless communication methods may include without limitation wireless networks, infrared communication, microwave communication, radio, and satellite transmission. Additionally, wireless communication may occur through various data communication specifications including without limitation Wi-Fi, Bluetooth, long-term evolution (LTE), Worldwide Interoperability for Microwave Access (WiMax), and Zigbee. Such coupling may occur also through wired communication media including without limitation controller area network (CAN) buses, coaxial cable, fiber optic cable, and twisted pair cable. Communication between devices may occur using one or more communication protocols including without limitation Open Platform Communications Unified Architecture (OPC UA), Z-Wave, and user data protocol (UDP) and transmission control protocol (TCP) sockets. Certain standards, specifications, protocols, and architectures may be suitable for defining real-time data communication within the remote monitoring and control system including without limitation Ethernet for Control Automation Technology (EtherCAT), EtherNet/IP, Process Field Net (PROFINET), Ethernet Powerlink, Sercos III, CC-Link, and Modbus.

On-site equipment 108 may include any and all equipment—whether physical (for example, drilling equipment, wireline tools, employee computers, gauges, meters, valves) or virtual (for example, software applications)—that may facilitate operations at a work site 150, that may be enabled for remote control using one or more of an interface computer 122, an audio-visual device 124, a control device 126, and a control computer 102. In one or more embodiments, on-site equipment 108 may provide on-site data or may be equipped with one or more sensors 104 to detect and provide on-site data.

In one or Mott embodiments, the remote monitoring and control system 100 may comprise a controller 118. In one or more exemplary embodiments, controller 118 may be configured for security purposes. For example, controller 118 may limit or direct data flow between work sites 150, resources 116, and remote sites 160. In one or more embodiments, controller 118 may enable information, processing, such as on-site data processing or command implementation. For example, controller 118 may direct data to an operator wearing an audio-visual device 124 to provide a notification regarding a particular resource at a work site 150 in an unsafe state. Likewise, controller 118 may provide instructions from resources 106 to the operator including instructions regarding disabling the resource to avoid an accident. In response, the operator may provide a command (for example, using a control device 126) based, at least in part, on the unsafe condition. Control computer 102 in turn, may direct the command to resources or equipment to shut off the resource in an unsafe state. As one of ordinary skill will understand, software may be designed to enable the controller 118 to act appropriately within the context of the system 100 mid the particular hydrocarbon recovery, exploration, operation, or services environment.

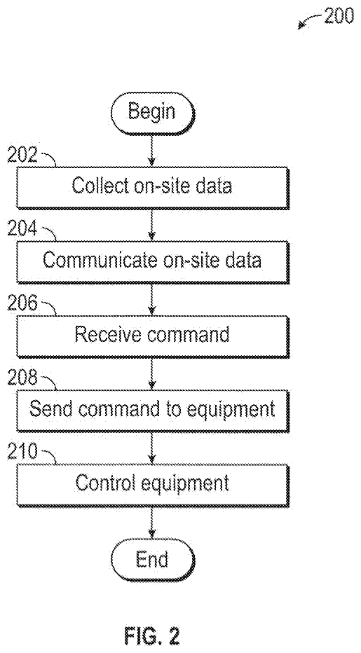

FIG. 2 is a flow diagram of a method, according to one or more aspects of the present disclosure. The method begins by collecting on-site data (step 202). As noted herein, on-site data may be collected using one or more sensors 104 and may be provided by on-site equipment 108. On-site data may be collected and may optionally be stored in one or more storage systems, including without limitation local storage and remote storage. On-site data may be provided to one or more audio-visual devices for communication to an operator (step 204). A control device 126 may receive a command from a control device 126 used by an operator (step 206). The command may be sent to one or more pieces of equipment (step 208) and the command may be used to control equipment on-site (step 210). In one or more embodiments, a network 112 may facilitate communication of on-site data and transmission of commands to equipment.

As described herein, interface computers 122, control computers 102, and controller 118 (generally, computers) may comprise any suitable machine or network of machines capable of communicating with other network equipped devices including without limitation on-site equipment, audio-visual devices, control devices, network devices, storage devices, and other resources and devices. Computers may comprise a processor or central processing unit configured for executing instructions, program instructions, process data, or any combination thereof. The processor may be configured to interpret and execute program instructions, software or other data retrieved and stored in memory, including without limitation read-only memory (ROM), random access memory (RAM), solid Slate memory, or disk-based memory.

Modifications, additions, or omissions may be made to computers without departing from the scope of the present disclosure. Any suitable configurations of components may be used. For example, components of computers may be implemented either as physical or logical components. Furthermore, in one or more embodiments, functionality associated with computers may be implemented in special purpose circuits or components. In one or more embodiments, functionality associated with components of computers may be implemented in configurable general-purpose circuit or components, such as configured computer program instructions.

In any embodiment, computers may include a non-transitory computer readable medium that stores one or more instructions where the one or more instructions when executed cause the processor to perform certain actions. As used herein, a computer may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. It should be understood that various changes, substitutions and alterations can be made herein without departing from the spirit and scope of the disclosure as defined by the claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are each defined herein to mean one or more than one of the element that it introduces.

What is claimed is:

1. A virtual job control system comprising:
one or more sensors for collecting data associated with one or more well-site equipment;
an audio-visual device for receiving the data and generating one or more notifications based, at least in part, on the data;
a control device for generating one or more commands based, at least in part, on the one or more notifications,
wherein the one or more commands alter one or more operations of the well site equipment; and
a network system coupled to the one or more sensors, the one or more well site equipment, the audio-visual device, and the control device.

2. The system Of claim 1, wherein the audio-visual device is an optical device, that is one or more of wearable and portable.

3. The system of claim 2, wherein the audio-visual device generates the one or more notifications in at least one of one or more augmented reality environments and one or more of virtual reality environments.

4. The system of claim 1, wherein the data collected by the one or more sensors further comprises real-time data, and
wherein the audio-visual device receives the real-time data and generates the one or more notifications in real-time based, at least in part, on the real-time data.

5. The system of claim 1, further comprising a computer,
wherein the computer comprises a processor, and
wherein the processor executes one or more instructions that at least one of prompts the one or more sensors to collect the data, receives the data from the one or more sensors, prepares the data for the audio-visual device, receives the one or more commands from the control device, and transmits the one or more commands to the one or more well site equipment.

6. The system of claim 1, further comprising a storage system for storing the data, wherein the storage system is coupled to the network system.

7. The system of claim 1, wherein the one or more well site equipment is in a first location and at least one of the audio-visual device and the control device is in a second location.

8. The system of claim 1, wherein the one or more well site equipment comprises one or more cementing equipment, and
wherein the data collected by the one or sensors comprises one or more of one or more cement properties, one or more slurry properties, and one or more performance indicators.

9. The system of claim 8, wherein the one or more cementing equipment comprises one or more of one or more actuators and one or more valves.

10. A method for controlling well site equipment comprising:
collecting data associated with one or more well site equipment;
providing one or more notifications using an audio-visual device based, at least in part, on the data;
generating a command using a control device based, at least in part, on the one or more notifications; and
controlling the one or more well site equipment based, at least in part, on the command.

11. The method of claim 10, wherein the one or more well site equipment is in a first location and at least one of the audio-visual device and the control device is in a second location.

12. The method of claim 10, wherein collecting the data further comprises using one or more sensors.

13. The method of claim 10, wherein controlling the one or more well site equipment further comprises transmitting the command to the one or more well site equipment via one or more of a local area network and a wide area network.

14. The method of claim 10, wherein tine one or more notifications comprise at least one of one or more audio notifications, one or more visual notifications, and one or more haptic notifications.

15. The method claim 10, wherein the one or more notifications comprises at least one of one or more alarms, one or more warnings, one or more videos, one or more documents, one or more maintenance information, one or more diagnostics, and one or more help guides.

16. The method of claim 10, wherein providing the one or more notifications further comprises displaying the data in at least one of one or more augmented reality environments and one or more of virtual reality environments.

17. The method of claim 10, wherein the data associated with one or more well site equipment is real-time data.

18. A method for controlling well site equipment comprising:
collecting data associated with one or more well site equipment;
providing one or more notifications using an audio-visual device based, at least in part, on the data and based, at least in part, on at least one of one or more configuration settings and one or more access controls;
generating a command using a control device based, at least in part, on the one or more notifications; and
controlling the one or more well site equipment based, at least in part, on the command.

19. The method of claim 18, further comprising storing the data in a data repository.

20. The method of claim 18, further comprising transmitting the command to the one or more well site equipment via one or more of a local area network and a wide area network.
